(19) United States
(12) Patent Application Publication
(10) Pub. No.: US 2025/0200871 A1
(43) Pub. Date: Jun. 19, 2025

(54) SYSTEM, METHOD AND PROCESS FOR MUON TOMOGRAPHY FOR BLOCK CAVING

(71) Applicant: Ideon Technologies Inc., Richmond (CA)

(72) Inventor: Douglas William SCHOUTEN, Surrey (CA)

(21) Appl. No.: 19/063,319

(22) Filed: Feb. 26, 2025

Related U.S. Application Data
(63) Continuation of application No. PCT/CA2023/051177, filed on Sep. 6, 2023.
(60) Provisional application No. 63/403,908, filed on Sep. 6, 2022.

(51) Int. Cl. G06T 15/50; G06F 17/11; G06T 17/20

(52) U.S. Cl. CPC G06T 15/506; G06F 17/11; G06T 17/20; G06T 2210/21

(57) ABSTRACT

A method for modelling a block cave mine comprising: at each of a plurality of spaced apart muon detection locations located in, or in a vicinity, of the block cave mine: detecting muons that interact with a muon detector over a time period; determining, from the interactions, measured directional muon intensities for a plurality of directions intersecting at the muon detection location; and optimizing an objective function to thereby obtain optimal values for a plurality of model parameters which parameterize a model of the block cave mine, wherein the objective function attributes cost to a difference between the measured directional muon intensities at the plurality of muon detection locations and modelled directional muon intensities at the plurality of muon detection locations, the modelled directional muon intensities based at least in part on the model parameters.

### CROSS-REFERENCE TO RELATED APPLICATIONS

This application is a continuation of Patent Cooperation Treaty (PCT) application No. PCT/CA2023/051177 having an international filing date of 6 Sep. 2023 which in turn claims priority from, and for the purposes of the United States of America claims the benefit under 35 U.S.C. § 119 in connection with, U.S. application No. 63/403,908 filed 6 Sep. 2022. All of the applications referred to in this paragraph are is hereby incorporated herein by reference for all purposes.

### FIELD

This technology relates generally to tracking cosmic ray muons through an array of underground detectors to develop a spatial (three-dimensional (3D)) model of various features of a block cave operation, and, in some embodiments, to update the spatial model over time to thereby provide a four-dimensional (4D) model of the block cave.

### BACKGROUND

Muon radiography is a method of detecting, imaging and monitoring subsurface or underground regions of interest by measuring the attenuation of subsurface muon intensity (underground). Detectors positioned adjacent to a region of interest measure a directional intensity of muons propagating through an overburden. This directional intensity is related to the amount of matter (e.g. the integrated opacity or density of matter) along a straight-line path in the direction of measurement. By situating detectors in different locations, radiographic images can be developed from multiple views of a region of interest, and these 2D images can be combined using tomographic algorithms to develop a 3D model of subsurface density.

Block caving is a mining technique for extracting ore from (typically) large ore bodies (typically) located deep underground. The ore body is undercut (i.e., a cave or void is created below the ore body). The ore body may then fracture and collapse (under its own weight and/or with various forms of assistance). The fractured rock piles up at the bottom of the cave and is extracted through various extraction channels—often with autonomous vehicles. This method allows large ore bodies to be extracted with minimal waste rock being produced. The cave has at least three characteristic features of interest:
1. The horizon, or top of the cave, also known as the “cave back”, from which rock is fracturing and collapsing;
2. The muck pile at the bottom of the cave, where the fractured rock collects and is extracted via extraction channels to an extraction layer (typically located below the case); and
3. The air gap between the horizon and the muck pile.

For operational safety, there is a desire to measure and/or monitor a thickness (a vertical, or z-dimension, thickness) of the air gap. Under certain conditions, if the air gap becomes too thick, a sudden collapse of rock can compress the air contained in the air gap, causing a high-energy pressure wave that can propagate through the mine, causing damage to the mine and/or to equipment, as well as potential injury and loss of life.

Further, there is a desire to be able to monitor, over periods of time, how the cave back develops. Lateral or transverse (e.g. x- and y-dimension) extents of the cave can be many hundreds of meters in each direction. Knowing the temporal evolution of the lateral/transverse variation in the vertical (z-coordinate) dimension of the cave back (e.g. how the z-coordinate of the cave back varies over the lateral/transverse (x and y) dimensions of the block cave) gives an indication of how the rock is fracturing and allows operators to know where (in the deposit) the ore is being extracted from. By referencing such information about the evolution of the cave back to a model of the ore body, important operational information can be deduced, and operational parameters can be changed, for example to ensure that the cave propagates through the ore body and does not undesirably deviate into surrounding “country rock” (which would result in large volumes of waste rock being removed, crushed, and transported, at considerable cost).

There is a desire to monitor the 3D evolution of a block cave over time, which in turn can be used to mitigate safety risks and increase efficiency.

### SUMMARY

One aspect of the invention provides a method for modelling a block cave mine. The method comprises: at each of a plurality of spaced apart muon detector detection locations in, or in a vicinity, of the block cave mine: detecting muons that interact with a muon detector over a time period; and determining, from the interactions, measured directional muon intensities for a plurality of directions intersecting at the muon detector detection location; and optimizing an objective function to thereby obtain optimal values for a plurality of model parameters which parameterize a model of the block cave mine, wherein the objective function attributes cost to a difference between the measured directional muon intensities at the plurality of muon detector detection locations and modelled directional muon intensities at the plurality of muon detector detection locations.

Another aspect of the invention provides a method for modelling a block cave mine. The method comprises: determining modelled directional muon intensities based on a density model of the block cave mine; detecting muons traversing through the block cave mine to generate muon trajectory data; determining measured directional muon intensities based on the muon trajectory data; and optimizing an objective function that attributes cost to a difference between the measured directional muon intensities and the modelled directional muon intensities to thereby obtain a plurality of optimal values for a plurality of model parameters which parameterize a model of the block cave mine.

Detecting muons traversing through the block cave mine may comprise, at each of a plurality of spaced apart muon detection locations in, or in a vicinity, of the block cave mine, detecting muons that interact with a muon detector over a time period.

Determining measured directional muon intensities may comprise determining, from the interactions, measured directional muon intensities for a plurality of directions intersecting at each of the plurality of muon detection locations.

The modelled directional muon intensities may be based at least in part on the model parameters.

The model parameters may comprise: cave back surface model parameters which parameterize a model of a cave back surface of the block cave mine; and upper muck pile surface model parameters which parameterize a model of an upper muck pile surface of the block cave mine. The cave back surface model parameters may comprise three-dimensional locations of a plurality of vertices of a polygonal surface mesh that models the cave back surface. The upper muck pile surface model parameters may comprise three-dimensional locations of a plurality of vertices of a polygonal surface mesh that models the upper muck pile surface.

The model parameters may comprise density profile parameters, which assign a density to each of a plurality of three-dimensional voxels in the block cave mine. The density profile parameters may also assign a density to each of a plurality of three-dimensional voxels in the earth adjacent to the block cave. The voxels may be polyhedral.

The density model parameters may comprise density profile parameters, which assign a density to each of a plurality of three-dimensional voxels in the block cave mine. The density profile parameters may also assign a density to each of a plurality of three-dimensional voxels in the earth adjacent to the block cave. The voxels may be polyhedral.

The method may comprise determining a height (z-dimension) profile of an air gap of the block cave mine, the height profile comprising a height (z-dimension) of the air gap at a plurality of transverse (x, y) locations. Determining the height profile of the air gap may comprise, for each transverse (x, y) location, determining a distance between the cave back surface model and the muck pile surface model.

The method may comprise determining a safety risk associated with the block cave mine, the safety risk based at least in part on the determined height profile of the air gap. Determining the safety risk may be based at least in part on one or more of: a depth of a muck pile of the block cave mine; a density of the muck pile, a number of open extraction channels of the block cave mine; locations of open extraction channels of the block cave mine; and water ingress into the block cave mine.

The method may comprise determining one or more extraction channels from which to extract rock from the block cave mine based at least in part the optimal values for the model parameters.

The method may comprise determining one or more locations to induce fracturing of or an ore body of the block cave mine based at least in part on the optimal values for the model parameters.

The measured directional muon intensities may have associated uncertainties. Optimizing the objective function may comprise accounting for the uncertainties in the measured directional muon intensities to thereby provide the optimal values of the model parameters with corresponding model parameter uncertainties. The optimal values of the model parameters my comprise probability densities or probability distributions of the values of the model parameters.

Optimizing the objective functions may comprise performing a Bayesian optimization process. Optimizing the objective function may comprise performing a Monte Carlo optimization process. The Monte Carlo optimization process may comprise one of more of: a Markov Chain Monte Carlo process and a sequential Monte Carlo process.

Optimizing the objective function may be based at least in part on prior mine information. The modelled directional muon intensities may be based at least in part on the prior mine information.

Optimizing the objective function based at least in part on the prior mine information may comprise incorporating the prior mine information into the optimization as one or more constraints. Incorporating the prior mine information into the optimization as one or more constraints may comprise incorporating the one or more constraints into the objective function. Incorporating the prior mine information into the optimization as one or more constraints may comprise limiting a solution space of the optimization based on the one or more constraints.

The prior mine information may comprise geometrical information which defines one or more regions of the block cave mine. The one or more regions may be selected from the group comprising: an ore body, an air gap and a muck pile.

The prior mine information may comprise density profile information which defines densities in one or more regions of the block cave mine. The one or more regions may be selected from the group comprising: an ore body, an air gap, a muck pile and earth adjacent to the ore body.

The prior mine information may comprise density profile information which defines a density for each of a plurality of voxels.

The method may comprise determining the modelled directional muon intensities at the plurality of muon detection locations based at least in part on the density profile information.

The prior mine information may comprise one or more of: information determined in a previous iteration of the optimization; and information determined prior to performing any iterations of the optimization.

The prior mine information may have associated uncertainty. Optimizing the objective function may comprise accounting for the uncertainty in the prior mine information to thereby provide the optimal values of the model parameters with corresponding model parameter uncertainties. The optimal values of the model parameters may comprise probability densities or probability distributions of the values of the model parameters.

Optimizing the objective function may comprise performing a Bayesian optimization process.

Optimizing the objective function may be based at least in part on additional measured information. The additional measured information may comprise one of more of: gravimetric information detected by one or more gravimetric sensors; seismic information detected by one or more seismic sensors; Radio Frequency Identification (RFID) information from one or more RFID devices; smart beacon information from one or more smart beacon devices; and image data from one or more downhole cameras.

Optimizing the objective function based at least in part on the additional measured information may comprise incorporating the additional measured information into the optimization as one or more constraints. Incorporating the additional measured information into the optimization as one or more constraints may comprise incorporating the one or more constraints into the objective function. Incorporating the additional measured information into the optimization as one or more constraints may comprise limiting a solution space of the optimization based on the one or more constraints.

Optimizing the objective function based at least in part on the additional measured information may comprise performing a joint optimization.

The additional measured information may have associated uncertainty. Optimizing the objective function may comprise accounting for the uncertainty in the additional measured information to thereby provide the optimal values of the model parameters with corresponding model parameter uncertainties. The optimal values of the model parameters may comprise probability densities or probability distributions of the values of the model parameters. Optimizing the objective function may comprise performing a Bayesian optimization process.

Optimizing the objective function may comprise performing tomographic reconstruction based at least in part on the measured directional muon intensities. The objective function may be based at least in part on the tomographic reconstruction. The modelled directional muon intensities may be based at least in part on the tomographic reconstruction.

The method may comprise repeating various steps over a plurality of time periods to provide a temporal model of the block cave mine, the temporal model characterized by the optimal values of the model parameters determined for each time period. The plurality of time periods may comprise: a plurality of overlapping time periods; and a plurality of sequential time periods.

At least one sub-plurality of muon detector detection locations may be provided by a single muon detector.

Another aspect of the invention provides a system for modelling a block cave mine. The system comprises: a plurality of spaced apart muon detectors distributed in, or in a vicinity of the block cave mine, each muon detector detecting muons that interact with the muon detector over a time period at one or more corresponding muon detector detection locations; and a controller in communication with the muon detectors. The controller is configured to: determine, based on the interactions between the muons and the muon detectors, measured directional muon intensities for a plurality of directions intersecting at each muon detector detection location; and optimize an objective function to thereby obtain optimal values for a plurality of model parameters which parameterize a model of the block cave mine, wherein the objective function attributes cost to a difference between the measured directional muon intensities at the plurality of muon detector detection locations and modelled directional muon intensities at the plurality of muon detector detection locations.

Another aspect of the invention provides a system for modelling a block cave mine. The system comprises: a plurality of spaced apart muon detectors distributed in, or in a vicinity of the block cave mine, each muon detector detecting muons that interact with the muon detector over a time period at one or more corresponding muon detection locations; and a controller in communication with the muon detectors. The controller is configured to: determine modelled directional muon intensities based on a density model of the block cave mine; detect muons traversing through the block cave mine to generate muon trajectory data; determine measured directional muon intensities based on the muon trajectory data; and optimize an objective function that attributes cost to a difference between the measured directional muon intensities and the modelled directional muon intensities to thereby obtain a plurality of optimal values for a plurality of model parameters which parameterize a model of the block cave mine.

The controller maybe configured to perform any of the method steps, combinations of method steps or sub-combinations of methods steps disclosed herein.

Other aspects of the invention provide methods comprising any features combinations of features and/or sub-combinations of features described herein.

Other aspects of the invention provide apparatus comprising any features combinations of features and/or sub-combinations of features described herein.

It is emphasized that the invention relates to all combinations of the above features, even if these are recited in different claims.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1 is a schematic side cross-sectional view of a muon detection system for monitoring a block cave mine according to an example embodiment. FIG. 1A is a schematic perspective view of a muon detector according to an example embodiment. FIGS. 1B and 1C are schematic views of a muon detector according to another example embodiment.

FIG. 2 is a schematic flowchart diagram of a method for generating a 3D representation of a block cave mine according to an example embodiment.

FIG. 2A shows an exemplary solid angle section that may be used in the directional discretization of the method of FIG. 2.

FIG. 3A is a schematic flowchart diagram of a method for using directional intensity values (or directional integrated opacity values) to determine a 3D representation of a block cave mine according to a particular embodiment. FIG. 3B is a schematic flowchart diagram of a method for using directional intensity values (or directional integrated opacity values) and density profiles to determine a 3D representation of a block cave mine according to a particular embodiment.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

Aspects of the invention provide systems and methods for using muon detectors for determining a spatial (three-dimensional (3D)) model of various features of a block cave operation and, in some embodiments, monitoring the 3D evolution of a block cave over time, which in turn can be used to mitigate safety risks and increase efficiency of a block caving operation.

Aspects of the invention provide methods and systems for modelling a block cave mine. In some aspects, the method comprises: at each of a plurality of spaced apart muon detection locations located in, or in a vicinity, of the block cave mine: detecting muons that interact with a muon detector over a time period; and determining, from the interactions, measured directional muon intensities for a plurality of directions intersecting at the muon detection location; and optimizing an objective function to thereby obtain optimal values for a plurality of model parameters which parameterize a model of the block cave mine, wherein the objective function attributes cost to a difference between the measured directional muon intensities at the plurality of muon detection locations and modelled directional muon intensities at the plurality of muon detection locations.

In some aspects, the method comprises: providing a density model of the block cave mine; determining modelled directional muon intensities based on the density model; detecting muons traversing through the block cave mine to generate muon trajectory data; determining measured directional muon intensities based on the muon trajectory data; and optimizing an objective function that attributes cost to a difference between the measured directional muon intensities and the modelled directional muon intensities to thereby obtain a plurality of optimal values for a plurality of model parameters which parameterize a model of the block cave mine.

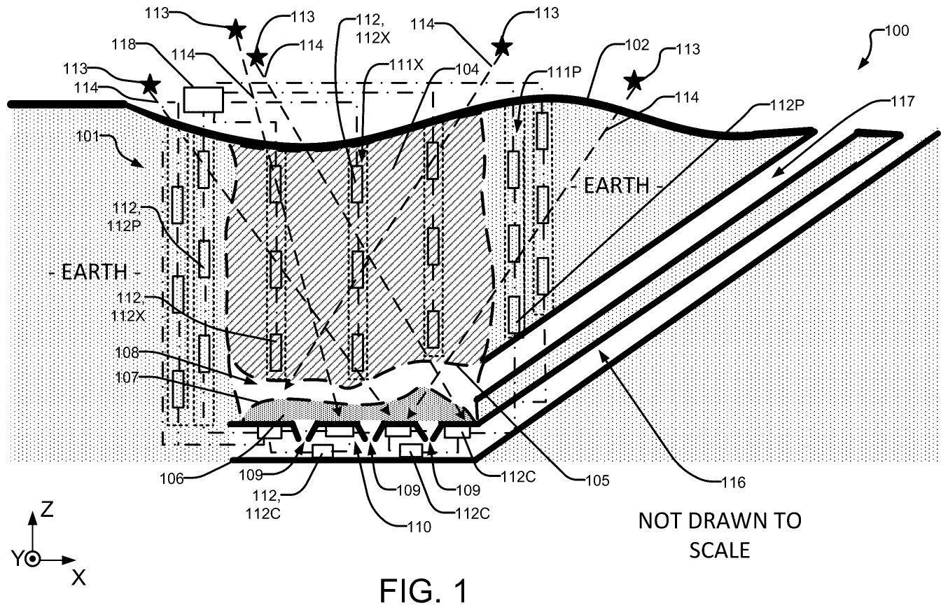

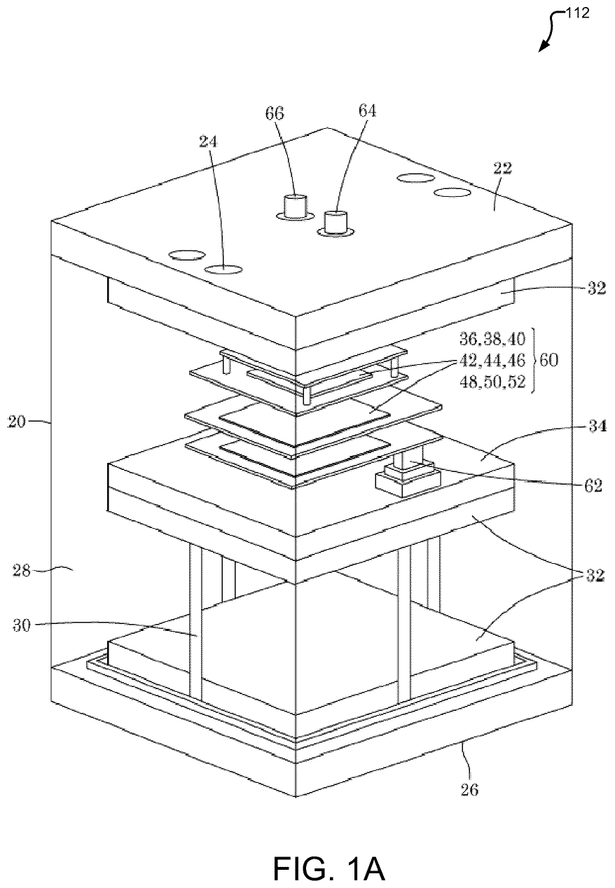

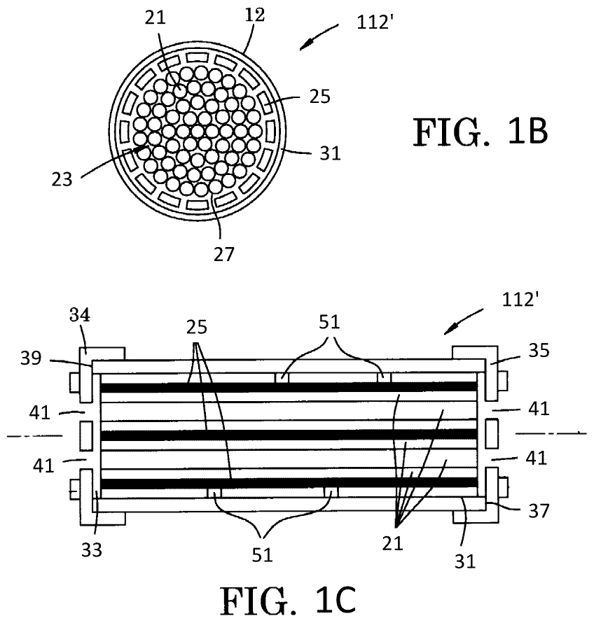

FIG. 1 is schematically illustrates a side cross-sectional view of a muon detection system 100 for monitoring a block cave mine 101 according to an example embodiment.

Block cave mine 101 comprises a number of features including: earth surface 102, an ore body 104 (schematically illustrated using diagonal hatching), a muck pile 106 (schematically illustrated using dotted (halftone) hatching), and an air gap 108 between a lower (cave back) surface 105 of ore body 104 and an upper surface 107 of muck pile 106. Air gap 108 may be created by any suitable technique known to those skilled in the field of block cave mining, such as, by way of example, breaking off a section of ore in ore body 104 (e.g. the section of ore may be undercut by drilling and/or blasting) and then retrieving the section of ore through an air gap mine access shaft 117. An extraction layer or system 110 may be created beneath muck pile 106. Rocks in muck pile 106 may be retrieved to extraction layer 110 through extraction channels (also known as draw points) 109 and then transported to surface 102 via mine access shaft 116. Block cave mine 101 may be located deep underground. By way of non-limiting example, surface 102 and muck pile 106 may be separated by a distance in the range of about 500 m to about 2,000 m.

Air gap 108 is defined by a cave back 105 (e.g. lower surface) of unmined ore body 104 and an upper surface 107 of muck pile 106. Consequently, the 3D geometry of air gap 108, including its shape and thickness, may be derived from the shape of cave back 105 of unmined ore body 104 and the shape of upper surface 107 of muck pile 106. Cave back 105 may change over time as ore body 104 fractures and collapses through air gap 108 into muck pile 106. Similarly, muck pile 106 and upper muck pile surface 107 may also change over time as the fractured and collapsed rock from ore body 104 falls into muck pile 106. Muon detection system 100 is configured to determine a spatial (three-dimensional (3D) model of various features of block cave mine 101 which comprises information on the surface shape of cave back 105 of ore body 104 and the surface shape of upper surface 107 of muck pile 106, thus facilitating determination of the shape of air gap 108 and calculating the vertical (z-dimension) thickness of air gap 108. In some embodiments, the model of block cave 101 may comprise other features or characteristics of block cave 101, such as a volumetric representation of ore body 104, muck pile 106, country rock located adjacent to ore body 104 and/or the like, the density of particular volumetric elements (e.g. voxels, which may comprise cuboid voxels or other polyhedral shaped (e.g. tetrahedral) voxels) in such a representation and/or the like. In some embodiments, muon detection system determines the evolution of a block cave model over time.

Typically, because of the economics involved in block cave mining (in particular the expense associated with building block cave mine 101), some geometrical and/or density information will be known about ore body 104 in advance of using the systems and methods of the various described herein. Such information may include information about the depth (in the z-dimension) and lateral/transverse extent (in the x- and y-dimensions) of ore body 104 and an estimate of a volumetric density profile (e.g. a density for each of a series of voxels) in and around ore body 104. This information obtained prior to the construction of block cave mine 101 may be obtained by any suitable technique. Typically, this information obtained prior to the construction of block cave mine 101 is determined by repeated drilling in a vicinity of ore body 104, extracting sample rock from the drilling sites and analyzing the same rock (typically in a lab) to determine this information.

Muon detection system 100 comprises a plurality of independently operable muon detectors 112. In some embodiments, each muon detector 112 comprises a muon tracking sensor for detecting muons passing through the sensor and trajectories associated with such passing muons, suitable memory for storing muon detection events, and suitable communication hardware (e.g. a network interface and/or the like) for communicating muon detection events to a controller 118, and an integrated processor for controlling the detector 112. Each muon detector 112 is at least configured to detect muons passing through muon detector 112 and for each such detected muon, determine a trajectory of the muon and record the muon trajectory with a time stamp. Muon detectors 112 may collect and store data relating to detected muon trajectories and may communicate such muon trajectory data to controller 118.

Muon detection system 100 comprises a plurality of muon detectors in various different locations relative to block cave mine 101. The locations of muon detectors 112 may be known and such detector location information may be communicated to or otherwise provided to controller 118. Muon detectors 112 may be located below muck pile 106. Such muon detectors 112 may be referred to as “cave muon detectors 112C”. In some embodiments, cave muon detectors 112C are located within or below extraction layer 110. In some embodiments, muon detectors 112 are located inside one or more boreholes 111P drilled in the earth around or outside of a lateral/transverse perimeter/periphery of block cave mine 101 (i.e. outside of ore deposit 104). Such muon detectors 112 may be referred to as “perimeter muon detectors 112P”. In some embodiments, muon detectors 112 are located inside one or more boreholes 111X drilled into ore body 104. Such muon detectors 112 may be referred to as “ore body muon detectors 112X”. In some embodiments, a plurality of muon detectors 112P are disposed at various depths (z-locations) inside boreholes 111P below surface 102. In some embodiments, a plurality of muon detectors 112X are disposed at various depths (z-locations) inside boreholes 111X between surface 102 and cave back 105.

In some embodiments, muon detectors 112C located within or below extraction layer 110 are oriented in generally horizontal (x and y) directions for desired exposure to muon flux. In some embodiments, muon detectors 112P and 112X located inside boreholes 111P and 111X are oriented in generally vertical (z) directions for desired exposure to muon flux. In some embodiments, muon tomography system may comprise some subset of the different types of muon detectors 112C, 112P and 112X.

In some embodiments, muon detectors 112 are geometrically spaced apart from one another and distributed throughout ore body 104, in the earth around a perimeter of ore body 104 and in extraction layer 110 beneath ore body 104.

FIG. 1A is a schematic perspective view of a muon detector 112 according to a non-limiting example embodiment. As shown in the specific embodiment of FIG. 1A, muon detector 112 comprises an enclosure 20 with a first endcap 22 containing feedthroughs 24 for electrical connections and support cables and a second endcap 26. Enclosure 20 may be of any suitable shape. In some embodiments, enclosure 20 comprises a rectangular shell. In some embodiments, enclosure 20 is cylindrically shaped. Enclosure 20 may be made of any suitable material, e.g. plastic, steel, aluminum, and/or other metal alloy. Enclosure 20 defines an enclosure interior 28. Support structures 30 are located in enclosure interior 28 to support a scintillator bar array 32. In some embodiments, scintillator bar array 32 is in a fixed orientation. A shelf 34 may hold various electronic components, e.g., accelerometers 36, gyroscopes 38, humidity sensor 40, temperature sensor 42, printed circuit boards (PCB) 44, field programmable gate array (FPGA) 46, magnetometer 48, processor 50 and memory 52 (which are referred to collectively as the data acquisition system (DAQ) 60). Accelerometers 36 and gyroscopes 38 may be configured for identifying a precise position and orientation of scintillator bar array 32 once installed. Humidity sensor 40 and temperature sensor 42 may be configured for monitoring the operational state of muon detector 112 and data acquisition system 60. In the embodiment shown in FIG. 1A, three scintillator bar arrays 32 are illustrated. This is not necessary. Muon detector 112 may comprise any suitable number of scintillator bar arrays 32. An exemplary photodetector 62 is shown in FIG. 1A. The power input feedthrough may comprise a suitable ruggedized DC electrical connector 64. The data input connector may comprise a ruggedized shielded data cable connector 66.

FIGS. 1B and 1C are schematic cross-section views of a muon detector 112′ according to another example embodiment. Without loss of generality, muon detector 112′ is suitable for use in boreholes, such as for perimeter muon detectors 112P and ore body muon detectors 112X. As shown in FIG. 1B, each borehole muon detector 112′ includes drift tubes 21 which are arranged in a bundle, generally referred to as bundle 23, with a plurality of scintillator members 25 around the periphery 27 of the bundle 23. Drift tubes 21 and the scintillator members 25 are encased in a housing 31, which is tubular. As shown in FIG. 1C, drift tubes 21 and scintillator members 25 are longitudinally disposed in the bore 33 of the housing 31 and lie overtop the drift tube bundle 23. It can be seen that scintillator members 25 are segmented from one another. There are no orthogonally disposed drift tubes 21. Housing 31 has an endcap 35 at each end 37, 39. Endcaps 34 include apertures 41 for electrical connections and support cables. A support matrix 51 locates and retains the drift tubes 21. Each drift tube 21 comprises an axially located anode wire and an inner surface that is coated with a cathode coating. As muons travel through a drift tube 21, the muon creates ionization that drifts toward the anode wire such that the radial position (how close the passes to the anode wire) can be determined by the time it takes electrons to drift to the anode wire. Such radial positions in different drift tubes 21 in bundle 23 create isochrones and a straight line fit to the isochrones may be used to determine an azimuthal trajectory of the muon. An estimate of the muon intersection along the longitudinal axis of a drift tube 21 may be determined by measuring the difference in time or current between the current pulses measured on each end of the anode wire. A zenith angle of the muon trajectory is determinable from regression of such longitudinal positions between drift tubes 21 in bundle 23.

Further details of exemplary and non-limiting muon detectors 112 are disclosed in Patent Cooperation Treaty (PCT) applications No. PCT/CA2020/050716, PCT/CA2020/050454 and PCT/CA2020/000036, which are hereby incorporated herein by reference in their entirety.

In some embodiments, muon detectors 112 are operatively interconnected in a network (shown by dash-and-dotted lines in FIG. 1) such that muon detectors 112 are capable of communicating some or all of the muon trajectory data to a controller 118 for aggregated analysis. Controller 118 may comprise a suitably configured (e.g. programmed) computer or may otherwise comprise one or more processors for handling data and for performing operations including various aspects of the methods described herein. Controller 118 may comprise or may have access to memory (not shown) for storing data. Controller 118 may comprise or have access to a network interface for transmitting and/or receiving data. In some embodiments, the network comprises a wireless network. In some embodiments, the network comprises a wired network. In some embodiments, controller 118 is located at surface 102 or near surface 102.

In some embodiments, muon detection system 100 comprises an integrated wireless network mesh interfacing with controller 118 and the array of muon detectors 112 such that some or all of controller 118 and the array of muon detectors 112 are accessible at any node on the integrated wireless network mesh, allowing the muon trajectory data to be aggregated across the integrated wireless network mesh.

In some embodiments, muon detection system 100 comprises mounting bracket(s) affixed to a roof or a wall of a drift, tunnel, or gallery associated with block cave mine 101, such that muon detectors 112 may be mounted on the mounting bracket(s). In some embodiments, the mounting bracket(s) comprise rotational or otherwise moveable mounts, such that muon detectors 112 mounted to rotational or otherwise moveable mounts may facilitate orienting muon detectors 112 relative to a region of interest within block cave mine 101 (for example, a detector plane of muon detector 112 could be oriented orthogonally to a trajectory from the detector 112 to a region of interest to improve sensitivity) if desired.

In addition to muon detectors 112, muon detection system 100 may comprise other types of geophysics sensors. In some embodiments, muon detection system 100 comprises one or more of: gravimeters configured to measure the Earth's gravitational field, which may enable estimation of rock density in volumes surrounding the gravimeter; seismic sensors configured to detect and measure seismic events, such as the fracturing or ore body 104 and the point of origin of such fracture events (using pluralities of spaced apart seismic sensors); seismic sensors configured to generate seismic signals and measure reflected signals to thereby infer geometric information about block cave mine 101; and/or RFID (radio frequency ID) instruments which may be placed into ore body 104 at known locations (e.g. at various depths in boreholes) and may be used (e.g. sacrificially or otherwise) to determine when such locations of ore body 104 collapse into muck pile 106. In some embodiments, one or more of such other types of geophysics sensors are combined with a corresponding muon detector 112 to form an integrated detector. In some embodiments, some or all of muon detectors 112 in muon detection system 100 are combined with at least one of: a gravimeter, a seismic sensor, a RFID instrument, and one or more smart beacon devices to form an integrated detector.

In FIG. 1, cosmic muons 113 may pass through block cave mine 101 (and regions adjacent to block cave mine) at various angles along muon trajectories 114. A muon 113 may intersect with any number of muon detectors 112 that are distributed around block cave mine 101 as muon 113 travels along its trajectory.

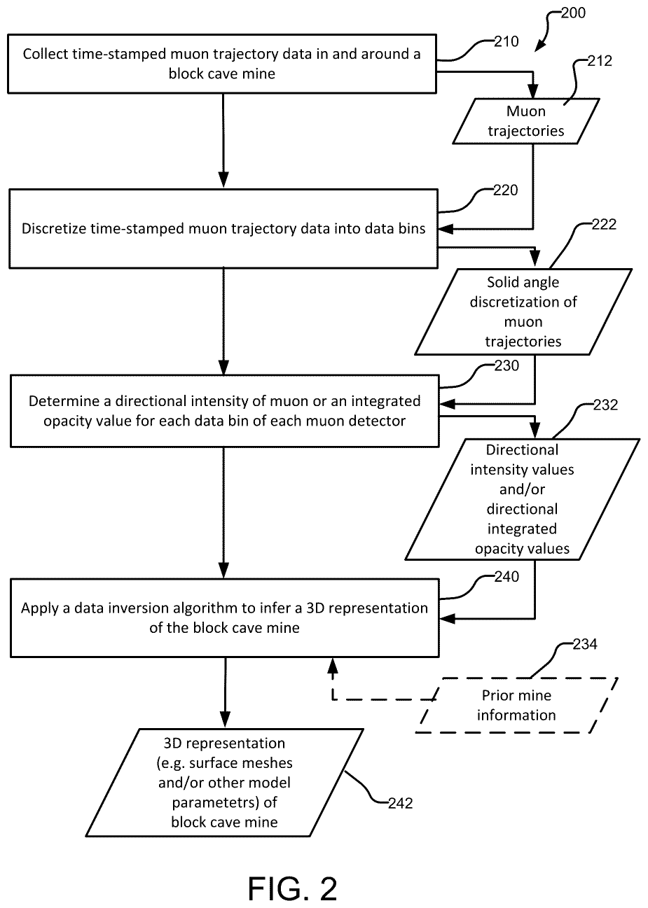

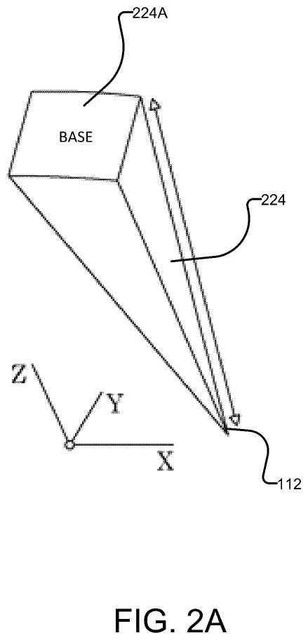

FIG. 2 is flowchart diagram of a method 200 for generating a 3D representation 242 of various features of a block cave mine (e.g. block cave mine 101) according to an example embodiment. The features of block cave mine 101 for which method 200 generates a 3D representation 242 include a surface geometry of cave back 105 and of upper muck pile surface 107.

Any muon detection systems disclosed herein (e.g. muon detection system 100) may be used to perform method 200. Method 200 may be controlled or implemented by controller 118 which may be configured (e.g. with suitable software) to perform various steps of the methods (including method 200) described herein. Method 200 may be performed (e.g. repeated) over suitable time intervals with each time interval generating a corresponding 3D representation 242 of block cave mine 101. For example, data are collected from tᵢ to tᵢ₊₁ to determine parameters of the 3D representation 242 of block cave mine 101 during the period from tᵢ to tᵢ₊₁. The time intervals over which method 200 is performed may be disjoint. In this manner, the evolution of block cave mine 101 over such time intervals can be determined.

Method 200 starts at block 210, which involves collecting muon trajectory data 212 from the plurality of muon sensors 112 distributed in and around block cave mine 101 as described above. Block 210 may involve collecting muon trajectory data for a configurable (e.g. user-configurable) period of time. Such a period of time may in some embodiments, comprise a time period between 5-60 days. Such a time period can change between iterations of method 200. For example, such a time period might start relatively long and may contract as block mine 101 evolves. Such a time period may be dependent on depth of block mine 101. For each muon detector 112, each muon detection event may comprise detecting a trajectory of a muon that passes through detector 112 and a corresponding time stamp of the muon detection event. The various trajectory and time stamp data independently collected by muon detectors 112 may be referred to herein as muon trajectory data 212. For each muon detector 112 and each muon detection event, muon trajectory data 212 may comprise: a suitable unit vector \hat{t} representative of a trajectory of the muon (e.g. î=<i\hat{x}, jŷ, k\hat{z}>, where \hat{x}, ŷ, \hat{z} are respectively unit vectors in the x, y and z directions with their origin at the location of the corresponding muon detector 112 and where |\hat{t}|=\sqrt{i²+j²+k²}=1); and a time stamp. It will be appreciated that over a suitable period of time, muon detectors 112 may detect a plurality of muon events and, consequently, muon trajectory data 212 may comprise, for each of a plurality of muon detectors 112, a plurality of trajectory unit vectors and a plurality of corresponding time stamps.

After a suitable period of time has elapsed, method 200 proceeds to block 220 which comprises parsing muon trajectory data 212 from each detector 112 into discretized data bins, with each data bin represented by a solid angle section. The output of block 220 may be referred to herein as solid angle discretization 222 of muon trajectory data 212. The block 220 process may be performed for each muon detector 112. In some embodiments, block 220 comprises abstracting each muon detector 112 as a point in space with the volume around the muon detector 112 represented by a notional sphere centered at the location of the muon detector 112. The notional sphere may then be discretized into a plurality of solid angle sections with an apex of each solid angle section located at the muon detector 112 (i.e. the center of the notional sphere) and a base of each section covering a portion of the surface area of the notional sphere. An exemplary solid angle section 224 with its base 224A is shown in FIG. 2A. The notional sphere is discretized such that the aggregate of all the bases of the solid angle sections completely covers the surface of the sphere. Each solid angle section may be characterized by a suitable trajectory (e.g. a unit vector oriented from its corresponding muon detector 112 toward a center of its base and/or by a unit vector oriented from its corresponding muon detector 112 along one of the edges of the solid angle section). For each muon detector 112, each solid angle section may be referred to as a solid angle bin or, for brevity, a data bin. Block 220 may comprise, for each muon detector 112, assigning each muon detection event into one discrete solid angle bin based on the trajectory associated with the muon detection event and whether the trajectory associated with the muon detection event falls within the solid angle section. It will be appreciated that abstracting each detector as a single spherical point is one of many possible ways to discretize muon trajectory data 212. For example, in some embodiments, one or more muon detectors 112 may be able to detect muon detection events at a discrete plurality of locations on any one muon detector 112. In some embodiments, block 220 may comprise, and there is no loss of generality in, further dividing one muon detector 112 into multiple “point” detectors and discretizing muon detection events for each point within a detector. Such division can be done ad infinitum and muon detectors 112 may be abstracted fully as extended bodies. For brevity and without loss of generality, the remainder of this description describes treating each muon detector 112 as a single “point” detector, it being understood that in some embodiments, one or more of detectors 112 could comprise a discrete array of point detectors and that the process of block 220 and the rest of method 200 described as being peformed for each detector 112, could be performed for each such point.

It will be appreciated that since muon trajectory data 212 is collected in block 210 over a period of time, solid angle discretization 222 of muon trajectory data 212 generated in block 220 comprises, for (or at the location of) each muon detector 112, a count (e.g. a number) of muon detection events that fall into each solid angle section/bin during that period of time (e.g. effectively, a solid angle histogram). For each detector 112 and for each solid angle bin, this count per unit time may be interpreted as an intensity of muons passing through the detector 112 for the trajectory associated with the solid angle bin.

Method 200 then proceeds to block 230 which involves, for each muon detector 112, converting solid angle discretization 222 into a directional intensity 232 and/or a directional integrated opacity 232. As discussed above, because muon trajectory data 212 is collected in block 210 over a period of time, solid angle discretization 222 determined in block 220 comprises a count for each solid angle bin associated with each detector 112 during that period of time. For each detector 112 and for each solid angle bin, the count divided by the time during which muon trajectory data 212 is collected is representative of a directional intensity at the location of the detector 112 and at the trajectory associated with the solid angle bin. In some embodiments, block 230 outputs a directional intensity 232 for each solid angle bin for each muon detector 112.

As is known to those familiar with subterranean muon tomography, there is a relationship between directional muon intensity at a particular location and the integrated opacity (or integrated density) between the particular location and the surface of the earth (e.g. surface 102 in the FIG. 1 illustration). In other words, muons, which typically exhibit uniform directional intensity across the surface of the earth, lose energy as they travel through dense matter (like the earth) via ionization. As such, where there are high density (or high opacity) objects on a trajectory between the surface of the earth and a subterranean muon detector location, there will be a correspondingly low directional muon intensity along that direction; and, conversely, where a trajectory between the surface of the earth and the subterranean muon detector location includes relatively low density (low opacity) objects, there will be a correspondingly high directional muon intensity along that direction. Specifically, directional muon intensity measured for a muon detector 112 at a particular direction exhibits a one-to-one relationship with the line integral of the density (opacity) along a line extending in that direction between the surface of the earth and the detector. In some embodiments, in addition to or as an alternative to determining a directional intensity 232 for each solid angle bin for each muon detector 112, block 230 may determine a directional integrated opacity for each solid angle bin for each muon detector 112. For brevity and without loss of generality, the remainder of this description describes block 230 as determining directional intensity 232 and the rest of the methods described herein as working with directional intensity 232, it being understood that directional integrated opacity/density or any other function (e.g. muon counts per unit time) exhibiting a one-to-one relationship with directional intensity could be used in addition to or as an alternative to directional intensity.

Method 200 then proceeds to block 240. Step 240 involves applying a data inversion (e.g. optimization) algorithm to determine a 3D representation 242 of the block cave mine. The block 240 data inversion (optimization) process may be based on directional intensity and/or directional integrated opacity values 232 output from block 230. The block 240 optimization process may optionally additionally be based on prior mine information 234. By way of non-limiting example, such optional prior mine information 234 may include: previously obtained mine geometry information (e.g. information about the geometry of ore deposit 104, the geometry of earth surrounding ore deposit 104, a profile of the boundary ore deposit 104 and the earth surrounding ore deposit 104, a surface profile of earth surface 102 and/or the like); information about the density (or opacity) of various regions of block cave mine 101 (which may comprise a discretization of the various regions of mine geometry into voxels (e.g. cuboid voxels or other polyhedral voxels) and an assignment of a density to each voxel, an assignment of uniform density to various regions of block cave mine 101 and/or the like); information about the total mass of the block cave system (which may be determined based on integrated density of various regions of block cave mine 101 over the volume(s) of various regions of the mine); and/or the like. Prior mine information 234 may include the locations of muon detectors 112. Such optional prior mine information 234 may come from any suitable process for determining characteristics (e.g. geometrical characteristics, physical characteristics (e.g. density) and/or other characteristics) of the mine 101 and/or the ore deposit 104. Such prior mine information 234 may come from previous iterations of method 200, muon tomography techniques used prior to any iterations of method 200, conventional techniques (e.g. drilling and core sampling) for investigating mine sites that may have occurred before the construction of block cave mine 101, conventional techniques for surveying or otherwise obtaining a profile of earth surface 102 and/or any other suitable technique for estimating characteristics of mine 101 and/or ore deposit 104.

The 3D representation 242 generated in block 240 may comprise, inter alia, surface models representative of cave back 105 and upper muck pile surface 107. In general, such surface models may comprise any suitable surface model characterized (or parameterized) by a corresponding set of surface model parameters. In currently preferred embodiments, the 3D representation 242 generated in block 240 comprises surface models for cave back 105 and upper muck pile surface 107, where each surface comprises a polygonal (e.g. triangular) surface mesh, where the model parameters comprise the 3D positions (e.g. (x,y,z) coordinates) of vertices that define the mesh. In other embodiments, the surface models of cave back 105 and upper muck pile surface 107 may be modeled by other surface models (e.g. Bezier curves, splines and/or the like) which are parameterized by other corresponding model parameters. For brevity and without loss of generality, the remainder of this description describes the models of cave back 105 and upper muck pile surface 107 as being parameterized by model parameters which comprise 3D vertex positions, it being understood that other surface models (other than polygonal mesh surface models) and other surface model parameters may be used in the place of 3D vertex positions.

In some embodiments, block 240 may output, and 3D representation 242 generated in block 240 may comprise, a 3D representation of air gap 108, which may comprise the vertical (z-dimension) distance between the cave back surface 105 and the upper muck pile surface 107 at a plurality of horizontal (x,y) coordinates. In some embodiments, block 240 may additionally determine, and 3D representation 242 generated in block 240 may comprise, volumetric mesh representations of various regions of block cave mine 101 and/or surrounding regions, such as ore body 104, air gap 108 and/or muck pile 106 and/or regions of the earth in a vicinity of mine 101. In some embodiments, block 240 may additionally determine, and 3D representation 242 generated in block 240 may comprise, a density profile (e.g. a density for each of a plurality of discretized voxels) of various regions of block cave mine 101 and/or surrounding regions, such as ore body 104, air gap 108, muck pile 106 and/or regions of the earth in a vicinity of mine 101.

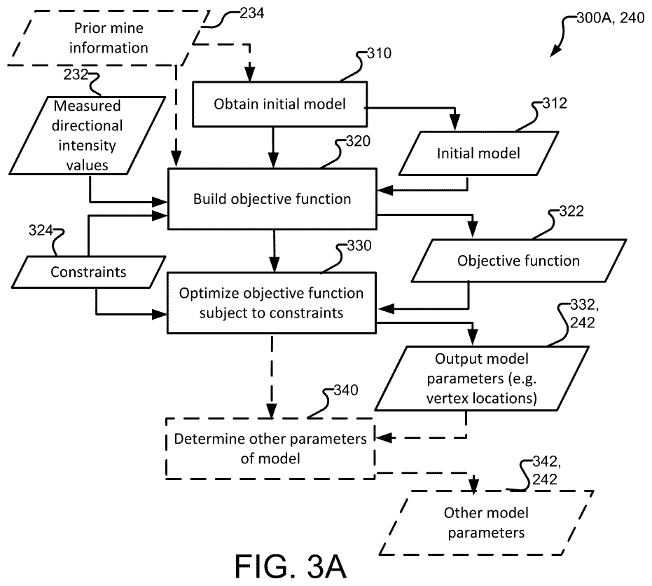

FIG. 3A is a schematic flowchart diagram of a method 300 for using directional intensity values (or directional integrated opacity values) 232 and, optionally, prior mine information 234, to determine a 3D representation 242 of block cave mine 101 according to a particular embodiment. Method 300A represents one non-limiting exemplary technique for performing block 240 of method 200. As discussed in more detail elsewhere herein, 3D mine representation 242 determined by method 300 may comprise model parameters 332 which, in some embodiments, comprise surface model parameters for cave back 105 and upper muck pile surface 107 and, in some embodiments, additionally comprise density profile model parameters for various regions of mine 101 and surrounding regions. The 3D mine representation 242 determined by method 300 may comprise additional model parameters 342 discussed in more detail below.

Method 300A starts in block 310 which involves obtaining an initial model 312 for the 3D geometry of block cave 101. As discussed above, in some embodiments, the block cave model may comprise a parameterized surface model corresponding to cave back 105 and a parameterized surface model corresponding to upper surface 107 of muck pile 106. In the exemplary embodiments described herein, these surface meshes comprise polygonal surface meshes parameterized by a plurality of vertices and the 3D locations of such vertices. As discussed above, in other embodiments, such surface models may comprise other types of parameterized surface models which use other parameters in the place of vertex locations.

In some embodiments, a block cave model M may comprise a matrix Mₛ having dimensionality N×3, where Nis the number of vertices in the surface models for cave back 105 and upper muck pile surface 107 and each vertex is characterized by (x,y,z) coordinates (see coordinate axes in FIG. 1). The 3D representation 242 of block cave mine 101 output from block 240 (method 200) and model parameters 332 output from block 330 (described in more detail below) may comprise the elements of matrix Mₛ (e.g. the positions of the N vertices corresponding the surfaces meshes for cave back 105 and muck pile upper surface 107). Method 300A uses initial model 312 and measured directional intensity values 232 to generate (e.g. to infer) an updated model M which may comprise updated vertex positions (model parameters) 332 for the model matrix Mₛ which explain the measured directional intensity values 232 measured by muon detectors 112.

In some embodiments, the block cave model M may optionally comprise a density profile (e.g. a density for each discrete voxel of a volumetric representation of various regions of block cave mine 101 and/or surrounding regions, such as ore body 104, air gap 108, muck pile 106 and/or regions of the earth in a vicinity of mine 101). In some embodiments, the block cave model M may optionally comprise a vector mₚ having size V where Vis the number of discrete voxels in the volumetric representations of mine 101 and surrounding regions and where each voxel is characterized by a corresponding density. The 3D representation 242 of block cave mine 101 and model parameters 332 output from block 330 may comprise the elements of vector mₚ (e.g. the densities of each voxel). Method 300A may use initial model 312 and measured directional intensity values 232 to determine an updated model M which may optionally comprise updated voxel densities (model parameters 332) for the model vector mₚ which explain the measured directional intensity values 232 measured by muon detectors 112.

Initial model 312 may be obtained in block 310 according to any of a number of techniques. In some embodiments, determining initial model 312 may comprise assigning assumed initial values to the matrix Mₛ (e.g. initial coordinates of the locations of the vertices or initial model parameters of other surface models). For example, with regard to surface models (characterized by matrix Mₛ) cave back 105 and muck pile upper surface 107 may be initially assumed to be flat (no variation in the z-direction—all vertices in each surface are assigned the same z coordinate) and the x-y coordinates of the vertices may be uniformly spread over some x-y range considered to encompass mine 101 and any surrounding region which forms part of the model. Where assumed initial coordinates are assigned to the vertices of the initial model 312 in block 310, such initial coordinates may respect some initial conditions or assumptions. By way of non-limiting example, such initial conditions may require that: the air gap 108 is greater than or equal to zero (e.g. the z-coordinates of the cave back vertices must be greater than or equal to the z-coordinates of the upper muck pile surface vertices at corresponding x-y locations); cave back surface only propagates upwards (e.g. the z-coordinates of the vertices of the cave back surface must be greater than the z-coordinates of such vertices determined in any previous iterations of methods 200/300); the total mass of the block cave mine 101 is preserved (subject to any mass that is removed via extraction layer 110) between iterations; and/or the like. Such initial conditions may be used to define the initial model that is refined further to yield output model parameters 242 of model M, or such initial conditions may be applied as hard or soft constraints 324.

In some embodiments, determining initial model 312 may optionally comprise assigning assumed initial values to the vector mₚ (e.g initial densities for the voxels to the density profile model). For example, densities of various voxels of one or more regions of block cave mine 101 and/or surrounding regions, such as ore body 104, air gap 108, muck pile 106 and/or regions of the earth in a vicinity of mine 101 may be measured or otherwise estimated by other suitable techniques (e.g. drilling and core sampling techniques) prior to commencing method 200. As another example, densities of the voxels of one or more regions of block cave mine 101 and/or surrounding regions, such as ore body 104, air gap 108, muck pile 106 and/or regions of the earth in a vicinity of mine 101 may be assumed to be constant and may be assigned initial values. For example, all voxels in ore body 104 may be assigned the same initial densities and/or all voxels in air gap 108 may be assigned the same initial densities. Initial conditions or assumptions similar to those discussed above in connection with the initial surface model may be respected when determining the initial density profile model.

In some embodiments, obtaining initial model 312 in block 310 may be based, at least in part, on prior mine information 234. As discussed above, prior mine information 234 may include previously obtained mine geometry information and/or density information, which may come from a previous iteration of method 200 or which may come from any other suitable process (e.g. drilling and core sampling) for determining geometrical and/or density characteristics of the mine 101, ore deposition 104 and/or regions of the earth surrounding mine 101. For example, where method 200 has been performed in a previous iteration, the surface meshes Mₛ of model M will be available as part of the 3D mine representation 242 output from the previous iteration and the previous iteration vertex positions may be assigned to initial model 312. As another example, where method 200 has been performed in a previous iteration, the density model vector mₚ of model M will be available as part of the 3D mine representation 242 output from the previous iteration and the previous densities may be assigned to initial model 312. The profile of earth surface 102 may be determined (e.g. by conventional surveying techniques) and may be part of prior mine information 234 used in block 312.

Method 300A then proceeds to block 320 which involves determining an objective function 322 to be used in the block 330 optimization. The block 320 objective function 322 compares measured directional intensity values 232 to directional intensity values that would be expected at the locations of muon detectors 112 if cave back 105 and upper muck pile surface 107 and, optionally, the volumetric density profile of mine 101 and surrounding areas were accurately described by the block cave model M. The set of measured directional intensity values 232 at the locations muon detectors 112 may be referred to herein as I_{D} and the set of directional intensity values predicted by model M at the locations muon detectors 112 may be referred to herein as I_{M}, I_{D} and I_{M} may be considered to be vectors having the same length, where each element of each vector corresponds to one intensity value at one muon detector location corresponding to one discrete solid angle section. As discussed above, and without loss of generality, the steps of method 200 may be performed using any one-to-one function of, or analogous to, intensity, such as the number of muons counted in a given section of solid angle within an exposure period tᵢ to tᵢ₊₁.

Intensity values IM may be determined based at least on part on the geometry of mine shaft 101 according to the model M and, in some embodiments, prior mine information 234. For example, mine shaft 101 may be geometrically partitioned into subterranean regions of assumed or assigned density/opacity based on the model M. Such regions may comprise, for example: air gap 108 and regions of extraction layer 110; the profile of earth surface 102, ore body 104; muck pile 107; earth surrounding mine (subterranean regions outside of ore body 104); and/or the like. Each such region may be assigned a corresponding opacity/density value. Intensity values I_{M} may then be obtained from the known distribution of muons above earth surface 102 and then modelling the propagation of such muons toward the locations of muon detectors 112 in straight line paths through the regions of different density/opacity to arrive at the locations of muon detectors 112 with directional intensities that correspond to the opacity/density in their respective paths to the locations of muon detectors 112.

In some embodiments, model M and/or prior mine information 234 may provide more detailed density information. As discussed above, in some embodiments, model M and/or prior mine information may comprise a density profile of the various regions of mine 101 and/or surrounding regions (e.g. a density value for each of a plurality of discrete voxels used to model mine 101 and/or surrounding regions) and such density profiles may be used to determine intensity values IM from the known distribution of muons above earth surface 102 and then modelling the propagation of such muons toward the locations of muon detectors 112 in straight line paths through the voxels of different density/opacity to arrive at the locations of muon detectors 112 with directional intensities that correspond to the opacity/density in their respective paths to the locations of muon detectors 112. It will be appreciated that in some embodiments, the density profile (e.g. density value for each of a plurality of discrete voxels) is part of the model M which is being optimized in the block 330 optimization discussed elsewhere herein. Such density profile information can be estimated from measured directional intensity values 232 using tomographic techniques and can be used to determine values for model directional intensities I_{M}. In some such embodiments, the block 330 optimization may comprise a joint optimization. In some embodiments, density profile data which is part of prior mine information 234 may be used to constrain the block 330 optimization.

The block 320 objective function 322 comprises a comparison between I_{D} and I_{M}. The block 320 objective function 322 may return a scalar value and may be constructed to assign higher values where I_{M} is more different than I_{D} and lower values where I_{M} is less different than (more similar to) I_{D}. In an exemplary embodiment, an objective function may comprise a suitable metric of the difference (error) between I_{D} and I_{M}. For example, the block 320 objective function may comprise a least absolute deviations (or L1-norm) or least squares (or L2-norm) of the difference between I_{D} and I_{M}. It will be appreciated that other suitable loss or error functions could be used to compare I_{D} and I_{M}. In some embodiments, the block 320 objective function 322 may also incorporate one or more terms that impose constraints 324. Such constraints 324 may be incorporated into objective function 322 in the form of terms that assign suitably high cost (high objective function values) to violations of the constraints 324.

Such constraints 324 may be provided in the form of limitations on the surface model parameters in block cave model M (e.g. vertex positions in surface matrix Mₛ), on the density profile in block cave model M (e.g. voxel density values in vector mₚ) in embodiments where model M includes a density profile, and/or in some other manner that limits the solution space of the block 330 optimization (discussed in more detail below). By way of non-limiting example, such constraints 324 may comprise: the air gap 108 being greater than or equal to zero (e.g. objective function 322 assigns high cost to any solution where the z-coordinates of the cave back surface 105 (e.g. cave back vertices) are less than the z-coordinates of the upper muck pile surface 107 (e.g. upper muck pile vertices) at corresponding x-y locations); cave back surface only propagates upwards (e.g. objective function 322 assigns high cost to any solution where the z-coordinates of cave back surface 105 (e.g. cave back vertices) are less than the z-coordinates of such vertices determined in any previous iterations of methods 200/300); and/or the like.

Another non-limiting example of such a constraint 324 is that the total mass of the block cave mine 101 is preserved (subject to any mass that is removed via extraction layer 110) between iterations; and/or the like. For example, where model M includes density profile data, the integrated mass of the block cave mine 101 plus any material removed via extraction layer 110 should remain constant and so objective function 322 may assign a high cost to solutions (e.g. density profiles and/or surface vertex positions) that lead to deviations from this total mass. Such a mass conservation constraint 324 can also be used where model M does not include density profile data, for example, if the density profile of ore body 104 is known or can be estimated from prior mine information 234 and the density profile of muck pile 106 can be known or estimated. For such conservation of mass constraints 324, the amount of mass removed from block cave mine 101 via extraction layer 110 can be measured from haulage data.

In some embodiments, some constraints 324 which may be incorporated into objective function 322 may comprise uncertainties which may be based on or associated with corresponding uncertainties in measured and/or modelled values. Such measured and/or modelled values may be part of prior mine information 234 and/or part of current model M, although this is not necessary. By way of non-limiting example, such measured and/or modelled values may include measured and/or modelled per voxel densities (which may be measured or modelled as part of prior mine information 324 or which may be part of current model M), measured mass removed from block cave mine 101 via extraction layer 110, measured directional intensity values 232 and/or the like. Such uncertainties may be incorporated into constraints 324 by treating the measured and/or modelled values as having distributions (e.g. normal distributions or other suitable distributions) around their expected values where the variance (or covariance matrices in the case of multivariate distributions) of such distributions are based on the confidence in such measured and/or modelled values. Where confidence in a measured and/or modelled value is relatively high, the measured and/or modelled value may have a relatively small variance; conversely, where confidence in a measured and/or modelled value is relatively low, the measured and/or modelled value may have a relatively large variance. Constraints 324 based on these uncertain measured and/or modelled values may then be incorporated into objective function 322 and may assign cost to model M solutions that deviate from these measured and/or modelled values, where the cost associated with deviation from such measured and/or modelled values may be relatively high where the confidence in such measured and/or modelled values is also high and relatively low where the confidence in such measured and/or modelled values is also low.

Once objective function 322 is constructed, method 300 proceeds to block 330 which involves performing an optimization on objective function 322 by varying the parameters of model M subject to constraints 324 to arrive at a set of output parameters 332 for block cave model M. In some embodiments, the block 330 optimization may comprise varying the surface model parameters of the block cave model M (e.g. varying the locations of the vertices of the modelled cave back 105 and upper muck pile surface 107—the elements of the above-discussed matrix Mₛ) to minimize objective function 322 subject to constraints 324 and then outputting, as output parameters 332 of block cave model M, the surface model parameters (e.g. vertex positions) corresponding to the minimum objective function. As discussed above, in some embodiments, model M may additionally comprise a density profile (e.g. the above-discussed vector mₚ) in which case the block 330 optimization may comprise varying the surface model parameters and the density model parameters (e.g. the elements of the above-discussed vector mₚ) to minimize objective function 332 subject to constraints 324 and then outputting: as output parameters 332 of block cave model M, the surface model parameters (e.g. vertex positions) and the density profile parameters (e.g. per voxel densities) corresponding to the minimum objective function. In some embodiments, the properties of objective function 322 may be used to determine uncertainties of the output parameters 332, or sometimes such uncertainties may be determined through repeated application of block 330 over randomly varied intensity values 232 or constraints 324.

In practice, the optimization in block 330 may not actually obtain an absolute minimum of objective function 322, but may instead arrive at some set of output model parameters 332 (e.g. surface model parameters and/or density model parameters) that corresponds at least approximately to a minimum objective function 322. The block 330 optimization may be subject to constraints 324. As discussed above, in some embodiments, constraints 324 may be incorporated into objective function 322. Constraints 324 may additionally or alternatively be used to constrain (subject to the respective uncertainties of constraints 324) the solution space of the block 330 optimization. Such constraints 324 incorporated into the block 330 optimization may be based on considerations similar to the constraints incorporated into the block 320 objective function 322. For example, constraints 324 incorporated into the block 330 optimization may be based on: the air gap 108 being greater than or equal to zero (e.g. the z-coordinates of the cave back vertices determined in the block 330 optimization being greater than or equal to the z-coordinates of the muck pile surface vertices determined in the block 330 optimization at corresponding x-y locations); the cave back surface only propagating upwards (e.g. the z-coordinates of the vertices of the cave back surface determined in the block 330 optimization being greater than the z-coordinates of such vertices determined in any previous iterations of methods 200/300); the total mass of the block cave mine 101 being preserved (subject to any mass that is removed via extraction layer 110) between iterations (e.g. the integrated density of the voxels of various regions of block cave mine 101 plus the mass of material removed from block cave 101 being preserved); and/or the like.

In some embodiments, the block 330 optimization is performed according to a so-called Bayesian inference technique. Bayesian inference techniques are useful for handling circumstances where there is uncertainty in the objective function 322, prior mine information 234 and/or constraints 324, which is useful in the context of the block 330 because various measured and/or modelled values may incorporate measurement uncertainty and/or associated modelling uncertainty. By way of non-limiting example, directional intensity values 232 may incorporate measurement uncertainty associated with muon trajectories 212 and/or the block 220 discretization of muon trajectories. As another non-limiting example, prior mine information 234 may comprise density profile values, which may be incorporated into constraints 324 and which may be used to model the directional intensities of muons arriving at the locations of muon detectors 112 and there may be measurement and/or modelling uncertainty in such prior mine information 234 which may lead to associated uncertainties in the modelled directional intensities. Bayesian optimization techniques permit such uncertainty may be carried through to output model parameters (e.g. surface model parameters and/or density profile model parameters) 332 output from the block 330 optimization. Where the block 330 optimization process comprises a Bayesian optimization process, the model parameters 332 output from the block 330 Bayesian optimization may comprise probability distributions or probability density functions for the optimal model parameters, where such probability distributions or probability density functions indicate the most probable optimal model parameter values and the probabilities that these model parameter values may be different from their respective most probable values.

Bayesian inference in the context of optimizing objective function 322 to determine model M output parameters 332 (e.g. surface model parameters (e.g. Mₛ) and/or density model parameters (e.g. mₚ)) corresponding to the minimum objective function 322 may comprise: (i) building a probability model (also known as a surrogate model or in Bayesian terms a posterior) of objective function 322 which is based on known evaluations of objective function 322 at candidate model parameters (the Bayesian prior); (ii) using the surrogate model to construct an acquisition function (e.g. α(M_{S}) or α(M_{S}, mₚ)) which balances the tradeoff between exploring new candidate model parameters and exploiting candidate model parameters known to be closer to optimal than other candidate model parameters; (iii) using the acquisition function (e.g. α(M_{S}) or α(M_{S}, mₚ)) to determine a new candidate set of model parameters for evaluation; (iv) evaluating objective function 322 at the new candidate set of model parameters; (v) incorporating the new candidate model parameters and corresponding valuation of objective function 322 into the surrogate model; and (vi) repeating steps (ii)-(v) until some desired convergence criteria and/or computational resource limitation criteria are met. At the conclusion of the Bayesian optimization process, the model parameters 332 output from the block 330 Bayesian optimization may comprise probability distributions or probability density functions for the optimal model parameters, where such probability distributions or probability density functions indicate the most probable optimal model parameter values and the probabilities that these model parameter values may be different from their respective most probable values.

In some embodiments, the optimization of the Bayesian acquisition function and/or the optimization of objective function 322 may comprise the use of so-called Monte Carlo techniques, such as, by way of non-limiting example, Markov Chain Monte Carlo (MCMC) techniques, sequential Monte Carlo techniques and/or the like. Monte Carlo optimization techniques comprise taking a “random walk” (e.g. along a Markov Chain) through the sample space (e.g. candidate model parameters for model M (e.g. surface model parameters and/or density model parameters), evaluating the function being optimized at the random sampled and deciding to accept or reject a sample based on some suitable decision criteria (of which there are many, such as the Metropolis technique, Gibbs sampling technique, slice sampling technique, Hamiltonian MCMC technique and/or the like) to build up a histogram of the function being optimized. This histogram can then lead to obtaining statistical parameterizations of the optimization (e.g. the expected (or most probable) optimal values and covariance (and/or probability densities and/or probability distributions) of the model M parameters (e.g. surface model parameters and/or density model parameters)) for the function being optimized based on discrete sums taken over the Markov Chain samples. The Markov chain random walk through possible samples can be constrained by constraints 324. Where used to optimize a Bayesian acquisition function, the output of the Monte Carlo optimization may comprise the expected (or most probable) value and corresponding probability densities or probability distributions for an optimal next choice for candidate model M parameters in the Bayesian optimization. Where used to optimize objective function 322, the output of the Monte Carlo optimization may comprise the expected values and covariance (and/or most probable values and/or probability densities or probability distributions) of optimal model M parameters that result in the model directional intensities I_{M} optimally fitting the measured directional intensities I_{D} 232. Such covariance may be used to determine uncertainties associated with the expected values of optimal mode M parameters.

In some embodiments, tuning of the random sampling in the parameter space may be useful to improving the computational efficiency of the Monte Carlo optimization technique and/or to make the optimization computationally tractable. Without limiting the general application of such sampling random sampling techniques, the strict random sampling may, in some embodiments, be revised to sample candidate models that satisfy the constraints, to sample candidate models according to the prior probability distributions of the initial model and/or initial conditions, to sample candidate models that limit some measure of overall model complexity or to sample candidate models which map to theoretical or otherwise predictable cave shapes and/or the likle.

In some embodiments, method 300 proceeds to optional block 340 which involves using optimized model parameters 332 (and possible prior mine information 234) to determine other parameters 342 of model M. For example, the techniques described above describe determining model M vertex positions 332 for cave back 105 and upper muck pile surface 107. In block 340, the meshes created by these vertices can be used to characterize air gap 108. For example, air gap 108 can be defined to be the z-dimension difference between the surface mesh corresponding to cave back 105 and the surface mesh corresponding to muck pile upper surface 107 at corresponding (x,y) coordinates.

Returning to FIG. 2, as discussed above, method 200 may be performed (e.g. repeated) at suitably time intervals with each time interval generating a corresponding 3D representation 242 of block cave mine 101. Such time periods can be overlapping temporal regions or distinct and contiguous time periods. Such time periods can also be spaced apart. Such time periods can be user configurable. In this manner, the evolution of block cave mine 101 over time can be determined by repeating method 200 in each time interval. Such time intervals may be user configurable and may comprise one or more hours, days and/or weeks in duration. This repetition of method 200 can lead to an animated model of block cave 101 by stitching together sequences of the block cave model M (3D representation 242) acquired over consecutive periods of time (e.g. consecutive iterations of method 200).

In some embodiments, determining 3D representation 242 (e.g. model parameters 332 such as surface model parameters and/or density model parameters and/or other model parameters 342 such as the heights of air gap 108) comprises determining uncertainties for such model parameters 332, 342 based on the muon trajectories data and/or the initial conditions.

In some embodiments, method 200 comprises generating 3D representation 242 (e.g. model parameters 332 such as surface model parameters and/or density model parameters and/or other model parameters 342 such as the heights of air gap 108) based on a subset of the available opacity data. The representation is generated from aggregating a plurality of representations over a period of time.

In some embodiments, additional geophysical sensors and corresponding data may be sued to in conjunction with the other techniques described herein for modeling block cave mine 101. Such geophysical sensors and data comprise:
1. Gravimetry sensors and data: by careful measurement of the Earth's gravitational field, changes in density near a gravimeter can be measured.
2. Seismic sensors and data: rock fracture events in the ore body 104 create seismic events that can be measured from multiple locations (passive seismic). By reconstructing the time of flight using measurements from multiple locations, the point of origin of the seismic event can be deduced, and the fracturing zones in block cave 101 can be observed. Additionally or alternatively, seismic signals can be generated using standard techniques at the surface of the earth, above block cave 101, and the reflections of the seismic signal from block cave 101 can also be used to infer 3D information about block cave 101.
3. RFI_{D} sensors and data: RFI_{D} devices may be placed in boreholes from surface, at various depths along the borehole, such that when the rock around them fractures and falls down, the devices fall with the rock. Each device has a unique RFI_{D} signature, and so by measuring the RFI_{D} responses in extraction layer 110, the minimum height of cave back 105 can be inferred since the precise 3D location of the RFI_{D} devices is recorded at the time of their emplacement.
4. Smart beacons are devices that are situated within the rock that is to be caved, via boreholes. Periodically these beacons emit a known electromagnetic impulse that can be detected from multiple distributed sensors, to triangulate the current location of the beacon. This allows operators to study the flow of material through the cave as the beacons move from ore body 104, through cave back 105 and through muck pile 106 along with the material that is being mined.
5. Direct downhole probes, wherein a camera or similar device is lowered down boreholes that penetrate through ore body 104, and by measuring the cable length downhole at which the camera or other device exits the rock and enters air gap 108, this provides a direct local measurement of cave back surface 105.

In some embodiments, method 200 comprises performing a joint reconstruction or joint optimization of block cave mine 101 using integration of muon trajectories data, and data from one or more other types of sensors such as: gravimetry data from gravimetric sensors, seismic data (passive or active) from seismic sensors, RFI_{D} data from RFI_{D} sensors, beacon data from beacon sensors and/or the like. With gravimetry data and/or direct downhole probes, objective function 322 may be expanded to take both measured directional intensities 232 (from muon detectors 112) and data from gravimetric and/or downhole probe sensors into account. For seismic data, which can be used to estimate locations of rock fracture events, the location(s) of rock fracture event(s) may be used to define an approximate cave back surface 105 that may be incorporated into method 300 as constraints 324 (e.g. no seismic events allowed in air gap 108). RFI_{D} and/or smart beacon data provide point estimates that may also be incorporated into method 300 as constraints 324. The smart beacon actually also provides an associated history, since it is known where the beacons originated (the rock in which they were originally embedded), and therefore the rock that they are surrounded by within muck pile 106. Such history could also provide a constraint 324 on the density profile for muck pile 106.

In some embodiments, method 200 further comprises assessing a safety hazard and/or risk for air gap collapse over regular operational intervals. Such risk may depend on the height (z-dimension) of air gap 108. Such a risk may also depend on the height (z-dimension) of muck pile 106, the density of muck pile 106, the number and/or location of open extraction channels (draw points) 109, water ingress, and/or other factors.

In some embodiments method 200 further comprises using the information derived from the 3D representation of the block cave mine to direct placement of explosives or drilling to induce fracturing in specified areas, in order to affect the future evolution of the block cave. For example, where it is observed (e.g. from subsequent iterations of method 200) that a portion of cave back 105 is not moving upward (i.e. ore body 104 above this section of cave back 105 is not fracturing), then induced fracturing techniques (e.g. explosives, drilling, hydro fracturing an/or the like) can be used to break up ore body 104 in these regions.

In some embodiments, method 200 further comprises using 3D representation 242 to determine a draw strategy (e.g. how to draw rock from muck pile 106 through extraction channels (draw points) 109). The draw strategy can impact operational safety, for example, by ensuring that draws through extraction channels (draw points) 109 are ordered and/or effected in such a manner that the height of air gap 108 does not reach a dangerous level. The draw strategy can also impact operational efficiency in the sense that draws through extraction channels (draw points) 109 are ordered and/or effected in such a manner that desirable rock (from ore body 104 and not from the earth surrounding ore body 104) is preferentially extracted from mine 101. For example, if it is known that a portion of cave back 105 has propagated through ore body 104 and is now in waste rock above or adjacent to ore body 104, then a draw strategy could be designed to discontinue, or reduce draw frequency of, extraction from channels 109 below this region.

Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMS, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, and other devices suitable for the purposes described herein.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

The invention has a number of non-limiting aspects. Non-limiting aspects of the invention comprise:
1. A method for modelling a block cave mine, the method comprising:
   at each of a plurality of spaced apart muon detection locations in, or in a vicinity, of the block cave mine: detecting muons that interact with a muon detector over a time period; and determining, from the interactions, measured directional muon intensities for a plurality of directions intersecting at the muon detection location; and
   optimizing an objective function to thereby obtain optimal values for a plurality of model parameters which parameterize a model of the block cave mine, wherein the objective function attributes cost to a difference between the measured directional muon intensities at the plurality of muon detection locations and modelled directional muon intensities at the plurality of muon detection locations.
2. The method of aspect 1 or any other aspect herein wherein the modelled directional muon intensities are based at least in part on the model parameters.
3. The method of any one of aspects 1 to 2 or any other aspect herein wherein the model parameters comprise: cave back surface model parameters which parameterize a model of a cave back surface of the block cave mine; and upper muck pile surface model parameters which parameterize a model of an upper muck pile surface of the block cave mine.
4. The method of aspect 3 or any other aspect herein wherein:
   the cave back surface model parameters comprise three-dimensional locations of a plurality of vertices of a polygonal surface mesh that models the cave back surface; and
   the upper muck pile surface model parameters comprise three-dimensional locations of a plurality of vertices of a polygonal surface mesh that models the upper muck pile surface.
5. The method of any one of aspects 1 to 4 or any other aspect herein wherein the model parameters comprise density profile parameters, which assign a density to each of a plurality of three-dimensional voxels in the block cave mine.
6. The method of aspect 5 or any other aspect herein wherein the density profile parameters also assign a density to each of a plurality of three-dimensional voxels in the earth adjacent to the block cave.
7. The method of any one of aspects 5 to 6 or any other aspect herein wherein the voxels are polyhedral.
8. The method of any of aspects 3 to 7 or any other aspect herein comprising determining a height (z-dimension) profile of an air gap of the block cave mine, the height profile comprising a height (z-dimension) of the air gap at a plurality of transverse (x, y) locations.
9. The method of aspect 8 or any other aspect herein wherein determining the height profile of the air gap comprises, for each transverse (x, y) location, determining a distance between the cave back surface model and the muck pile surface model.
10. The method of any one of aspects 8 to 9 or any other aspect herein comprising determining a safety risk associated with the block cave mine, the safety risk based at least in part on the determined height profile of the air gap.
11. The method of aspect 10 or any other aspect herein wherein determining the safety risk is based at least in part on one or more of: a depth of a muck pile of the block cave mine; a density of the muck pile, a number of open extraction channels of the block cave mine; locations of open extraction channels of the block cave mine; and water ingress into the block cave mine.
12. The method of any one of aspects 1 to 11 or any other aspect herein comprising determining one or more extraction channels from which to extract rock from the block cave mine based at least in part the optimal values for the model parameters.
13. The method of any one of aspects 1 to 12 or any other aspect herein comprising determining one or more locations to induce fracturing of or an ore body of the block cave mine based at least in part on the optimal values for the model parameters.
14. The method of any one of aspects 1 to 13 or any other aspect herein wherein the measured directional muon intensities have associated uncertainties and wherein optimizing the objective function comprises accounting for the uncertainties in the measured directional muon intensities to thereby provide the optimal values of the model parameters with corresponding model parameter uncertainties.
15. The method of any one of aspects 1 to 14 or any other aspect herein wherein the optimal values of the model parameters comprise probability densities or probability distributions of the values of the model parameters.
16. The method of any one of aspects 1 to 15 or any other aspect herein wherein optimizing the objective function comprises performing a Bayesian optimization process.
17. The method of any one of aspects 1 to 16 or any other aspect herein wherein optimizing the objective functions comprises performing a Monte Carlo optimization process.
18. The method of aspect 17 or any other aspect herein wherein the Monte Carlo optimization process comprises one of more of: a Markov Chain Monte Carlo process and a sequential Monte Carlo process.
19. The method of any one of aspects 1 to 18 or any other aspect herein wherein optimizing the objective function is based at least in part on prior mine information.
20. The method of aspect 19 or any other aspect herein wherein the modelled directional muon intensities are based at least in part on the prior mine information.
21. The method of any one of aspects 19 to 20 or any other aspect herein wherein optimizing the objective function based at least in part on the prior mine information comprises incorporating the prior mine information into the optimization as one or more constraints.
22. The method of aspect 21 or any other aspect herein wherein incorporating the prior mine information into the optimization as one or more constraints comprises incorporating the one or more constraints into the objective function.
23. The method of any one of aspects 21 to 22 or any other aspect herein wherein incorporating the prior mine information into the optimization as one or more constraints comprises limiting a solution space of the optimization based on the one or more constraints.
24. The method of any one of aspects 19 to 23 or any other aspect herein wherein the prior mine information comprises geometrical information which defines one or more regions of the block cave mine, the one or more regions selected from the group comprising: an ore body, an air gap and a muck pile.
25. The method of any one of aspects 19 to 24 or any other aspect herein wherein the prior mine information comprises density profile information which defines densities in one or more regions of the block cave mine, the one or more regions selected from the group comprising: an ore body, an air gap, a muck pile and earth adjacent to the ore body.
26. The method of any one of aspects 19 to 24 or any other aspect herein wherein the prior mine information comprises density profile information which defines a density for each of a plurality of voxels.
27. The method of any one of aspects 25 to 26 or any other aspect herein comprising determining the modelled directional muon intensities at the plurality of muon detection locations based at least in part on the density profile information.
28. The method of any one of aspects 19 to 27 or any other aspect herein wherein the prior mine information comprises one or more of: information determined in a previous iteration of the optimization; and information determined prior to performing any iterations of the optimization.
29. The method of any one of aspects 19 to 28 or any other aspect herein wherein the prior mine information has associated uncertainty and wherein optimizing the objective function comprises accounting for the uncertainty in the prior mine information to thereby provide the optimal values of the model parameters with corresponding model parameter uncertainties.
30. The method of aspect 29 or any other aspect herein wherein the optimal values of the model parameters comprise probability densities or probability distributions of the values of the model parameters.
31. The method of any one of aspects 29 to 30 or any other aspect herein wherein optimizing the objective function comprises performing a Bayesian optimization process.
32. The method of any one of aspects 1 to 31 or any other aspect herein wherein optimizing the objective function is based at least in part on additional measured information.
33. The method of aspect 32 or any other aspect herein wherein the additional measured information comprises one of more of: gravimetric information detected by one or more gravimetric sensors; seismic information detected by one or more seismic sensors; Radio Frequency Identification (RFID) information from one or more RFI_{D} devices; smart beacon information from one or more smart beacon devices; and image data from one or more downhole cameras.
34. The method of any one of aspects 32 to 33 wherein optimizing the objective function based at least in part on the additional measured information comprises incorporating the additional measured information into the optimization as one or more constraints.
35. The method of aspect 34 or any other aspect herein wherein incorporating the additional measured information into the optimization as one or more constraints comprises incorporating the one or more constraints into the objective function.
36. The method of any one of aspects 34 to 35 or any other aspect herein wherein incorporating the additional measured information into the optimization as one or more constraints comprises limiting a solution space of the optimization based on the one or more constraints.
37. The method of any one of aspects 32 to 36 or any other aspect herein wherein optimizing the objective function based at least in part on the additional measured information comprises performing a joint optimization.
38. The method of any one of aspects 32 to 37 or any other aspect herein wherein the additional measured information has associated uncertainty and wherein optimizing the objective function comprises accounting for the uncertainty in the additional measured information to thereby provide the optimal values of the model parameters with corresponding model parameter uncertainties.
39. The method of aspect 38 or any other aspect herein wherein the optimal values of the model parameters comprise probability densities or probability distributions of the values of the model parameters.
40. The method of any one of aspects 38 to 39 or any other aspect herein wherein optimizing the objective function comprises performing a Bayesian optimization process.
41. The method of any one of aspects 1 to 40 or any other aspect herein wherein optimizing the objective function comprises performing tomographic reconstruction based at least in part on the measured directional muon intensities.
42. The method of aspect 41 or any other aspect herein wherein the objective function is based at least in part on the tomographic reconstruction.
43. The method of any one of aspects 41 to 42 or any other aspect herein wherein the modelled directional muon intensities are based at least in part on the tomographic reconstruction.
44. The method of any one of aspects 1 to 43 or any other aspect herein comprising repeating the steps of aspect 1 over a plurality of time periods to provide a temporal model of the block cave mine, the temporal model characterized by the optimal values of the model parameters determined for each time period.
45. The method of aspect 44 or any other aspect herein wherein the plurality of time periods comprise: a plurality of overlapping time periods; and a plurality of sequential time periods.
46. The method of any one of aspects 1 to 45 or any other aspect herein wherein at least one sub-plurality of muon detection locations are provided by a single muon detector.
47. A system for modelling a block cave mine, the system comprising:
   a plurality of spaced apart muon detectors distributed in, or in a vicinity of the block cave mine, each muon detector detecting muons that interact with the muon detector over a time period at one or more corresponding muon detection locations;
   a controller in communication with the muon detectors, the controller configured to:
   determine, based on the interactions between the muons and the muon detectors, measured directional muon intensities for a plurality of directions intersecting at each muon detection location;
   optimize an objective function to thereby obtain optimal values for a plurality of model parameters which parameterize a model of the block cave mine, wherein the objective function attributes cost to a difference between the measured directional muon intensities at the plurality of muon detection locations and modelled directional muon intensities at the plurality of muon detection locations.
48. The system of aspect 47 or any other aspect herein wherein the modelled directional muon intensities are based at least in part on the model parameters.
49. The system of any one of aspects 47 to 48 or any other aspect herein wherein the model parameters comprise: cave back surface model parameters which parameterize a model of a cave back surface of the block cave mine; and upper muck pile surface model parameters which parameterize a model of an upper muck pile surface of the block cave mine.
50. The system of aspect 49 or any other aspect herein wherein:
   the cave back surface model parameters comprise three-dimensional locations of a plurality of vertices of a polygonal surface mesh that models the cave back surface; and
   the upper muck pile surface model parameters comprise three-dimensional locations of a plurality of vertices of a polygonal surface mesh that models the upper muck pile surface.
51. The system of any one of aspects 47 to 50 or any other aspect herein wherein the model parameters comprise density profile parameters, which assign density to each of a plurality of three-dimensional voxels in the block cave mine.
52. The system of aspect 51 or any other aspect herein wherein the density profile parameters also assign density to each of a plurality of three-dimensional voxels in the earth adjacent to the block cave.
53. The system of any one of aspects 51 to 52 or any other aspect herein wherein the voxels are polyhedral.
54. The system of any of aspects 49 to 53 or any other aspect herein wherein the controller is configured to determine a height (z-dimension) profile of an air gap of the block cave mine, the height profile comprising a height (z-dimension) of the air gap at a plurality of transverse (x, y) locations.
55. The system of aspect 54 or any other aspect herein wherein determining the height profile of the air gap comprises, for each transverse (x, y) location, determining a distance between the cave back surface model and the muck pile surface model.
56. The system of any one of aspects 54 to 55 or any other aspect herein wherein the controller is configured to determine a safety risk associated with the block cave mine, the safety risk based at least in part on the determined height profile of the air gap.
57. The system of aspect 56 or any other aspect herein wherein determining the safety risk is based at least in part on one or more of: a depth of a muck pile of the block cave mine; a density of the muck pile, a number of open extraction channels of the block cave mine; locations of open extraction channels of the block cave mine; and water ingress into the block cave mine.
58. The system of any one of aspects 47 to 57 or any other aspect herein wherein the controller is configured to determine one or more extraction channels from which to extract rock from the block cave mine based at least in part the optimal values for the model parameters.
59. The system of any one of aspects 47 to 58 or any other aspect herein wherein the controller is configured to determine one or more locations to induce fracturing of or an ore body of the block cave mine based at least in part on the optimal values for the model parameters.
60. The system of any one of aspects 47 to 59 or any other aspect herein wherein the measured directional muon intensities have associated uncertainties and wherein optimizing the objective function comprises accounting for the uncertainties in the measured directional muon intensities to thereby provide the optimal values of the model parameters with corresponding model parameter uncertainties.
61. The system of any one of aspects 47 to 60 or any other aspect herein wherein the optimal values of the model parameters comprise probability densities or probability distributions of the values of the model parameters.
62. The system of any one of aspects 47 to 61 or any other aspect herein wherein optimizing the objective function comprises performing a Bayesian optimization process.
63. The system of any one of aspects 47 to 62 or any other aspect herein wherein optimizing the objective functions comprises performing a Monte Carlo optimization process.
64. The system of aspect 63 or any other aspect herein wherein the Monte Carlo optimization process comprises one of more of: a Markov Chain Monte Carlo process and a sequential Monte Carlo process.
65. The system of any one of aspects 47 to 64 or any other aspect herein wherein optimizing the objective function is based at least in part on prior mine information.
66. The system of aspect 65 or any other aspect herein wherein the modelled directional muon intensities are based at least in part on the prior mine information.
67. The system of any one of aspects 65 to 66 or any other aspect herein wherein optimizing the objective function based at least in part on the prior mine information comprises incorporating the prior mine information into the optimization as one or more constraints.
68. The system of aspect 67 or any other aspect herein wherein incorporating the prior mine information into the optimization as one or more constraints comprises incorporating the one or more constraints into the objective function.
69. The system of any one of aspects 67 to 68 or any other aspect herein wherein incorporating the prior mine information into the optimization as one or more constraints comprises limiting a solution space of the optimization based on the one or more constraints.
70. The system of any one of aspects 65 to 69 or any other aspect herein wherein the prior mine information comprises geometrical information which defines one or more regions of the block cave mine, the one or more regions selected from the group comprising: an ore body, an air gap and a muck pile.
71. The system of any one of aspects 65 to 70 or any other aspect herein wherein the prior mine information comprises density profile information which defines densities in one or more regions of the block cave mine, the one or more regions selected from the group comprising: an ore body, an air gap, a muck pile and earth adjacent to the ore body.
72. The system of any one of aspects 65 to 70 or any other aspect herein wherein the prior mine information comprises density profile information which defines a density for each of a plurality of voxels.
73. The system of any one of aspects 71 to 72 or any other aspect herein wherein the controller is configured to determine the modelled directional muon intensities at the plurality of muon detection locations based at least in part on the density profile information.
74. The system of any one of aspects 65 to 73 or any other aspect herein wherein the prior mine information comprises one or more of: information determined in a previous iteration of the optimization; and information determined prior to performing any iterations of the optimization.
75. The system of any one of aspects 65 to 74 or any other aspect herein wherein the prior mine information has associated uncertainty and wherein optimizing the objective function comprises accounting for the uncertainty in the prior mine information to thereby provide the optimal values of the model parameters with corresponding model parameter uncertainties.
76. The system of aspect 75 or any other aspect herein wherein the optimal values of the model parameters comprise probability densities or probability distributions of the values of the model parameters.
77. The system of any one of aspects 75 to 76 or any other aspect herein wherein optimizing the objective function comprises performing a Bayesian optimization process.
78. The system of any one of aspects 47 to 77 or any other aspect herein wherein optimizing the objective function is based at least in part on additional measured information.
79. The system of aspect 78 or any other aspect herein wherein the additional measured information comprises one of more of: gravimetric information detected by one or more gravimetric sensors; seismic information detected by one or more seismic sensors; Radio Frequency Identification (RFID) information from one or more RFI_{D} devices; smart beacon information from one or more smart beacon devices; and image data from one or more downhole cameras.
80. The system of any one of aspects 78 to 79 wherein optimizing the objective function based at least in part on the additional measured information comprises incorporating the additional measured information into the optimization as one or more constraints.
81. The system of aspect 80 or any other aspect herein wherein incorporating the additional measured information into the optimization as one or more constraints comprises incorporating the one or more constraints into the objective function.
82. The system of any one of aspects 80 to 81 or any other aspect herein wherein incorporating the additional measured information into the optimization as one or more constraints comprises limiting a solution space of the optimization based on the one or more constraints.
83. The system of any one of aspects 78 to 82 or any other aspect herein wherein optimizing the objective function based at least in part on the additional measured information comprises performing a joint optimization.
84. The system of any one of aspects 78 to 83 or any other aspect herein wherein the additional measured information has associated uncertainty and wherein optimizing the objective function comprises accounting for the uncertainty in the additional measured information to thereby provide the optimal values of the model parameters with corresponding model parameter uncertainties.
85. The system of aspect 84 or any other aspect herein wherein the optimal values of the model parameters comprise probability densities or probability distributions of the values of the model parameters.
86. The system of any one of aspects 84 to 85 or any other aspect herein wherein optimizing the objective function comprises performing a Bayesian optimization process.
87. The system of any one of aspects 47 to 86 or any other aspect herein wherein optimizing the objective function comprises performing tomographic reconstruction based at least in part on the measured directional muon intensities.
88. The system of aspect 87 or any other aspect herein wherein the objective function is based at least in part on the tomographic reconstruction.
89. The system of any one of aspects 87 to 88 or any other aspect herein wherein the modelled directional muon intensities are based at least in part on the tomographic reconstruction.
90. The system of any one of aspects 47 to 89 or any other aspect herein wherein the controller is configured to repeat the steps of determining the measured directional muon intensities and optimizing the objective function to thereby obtain optimal values for the plurality of model parameters over a plurality of time periods to provide a temporal model of the block cave mine, the temporal model characterized by the optimal values of the model parameters determined for each time period.
91. The system of aspect 90 or any other aspect herein wherein the plurality of time periods comprise: a plurality of overlapping time periods; and a plurality of sequential time periods.
92. The system of any one of aspects 47 to 91 or any other aspect herein wherein at least one sub-plurality of muon detection locations are provided by a single muon detector.
93. A method for modelling a block cave mine, the method comprising:
   determining modelled directional muon intensities based on a density model of the block cave mine;
   detecting muons traversing through the block cave mine to generate muon trajectory data;
   determining measured directional muon intensities based on the muon trajectory data; and
   optimizing an objective function that attributes cost to a difference between the measured directional muon intensities and the modelled directional muon intensities to thereby obtain a plurality of optimal values for a plurality of model parameters which parameterize a model of the block cave mine.
94. The method of aspect 93 or any other aspect herein wherein detecting muons traversing through the block cave mine comprises at each of a plurality of spaced apart muon detection locations in, or in a vicinity, of the block cave mine: detecting muons that interact with a muon detector over a time period.
95. The method of aspect 94 or any other aspect herein wherein determining measured directional muon intensities comprises determining, from the interactions, measured directional muon intensities for a plurality of directions intersecting at each of the plurality of muon detection locations.
96. The method of any one of aspects 93 to 95 or any other aspect herein wherein the modelled directional muon intensities are based at least in part on the plurality of model parameters.
97. The method of any one of aspects 93 to 96 or any other aspect herein wherein the model parameters comprise: cave back surface model parameters which parameterize a model of a cave back surface of the block cave mine; and upper muck pile surface model parameters which parameterize a model of an upper muck pile surface of the block cave mine.
98. The method of aspect 97 or any other aspect herein wherein:
   the cave back surface model parameters comprise three-dimensional locations of a plurality of vertices of a polygonal surface mesh that models the cave back surface; and
   the upper muck pile surface model parameters comprise three-dimensional locations of a plurality of vertices of a polygonal surface mesh that models the upper muck pile surface.
99. The method of any one of aspects 93 to 98 or any other aspect herein wherein the density model comprises density profile parameters, which assign density to each of a plurality of three-dimensional voxels in the block cave mine.
100. The method of aspect 99 or any other aspect herein wherein the density profile parameters also assign density to each of a plurality of three-dimensional voxels in the earth adjacent to the block cave mine.
101. The method of any one of aspects 99 to 100 or any other aspect herein wherein the voxels are polyhedral.
102. The method of any of aspects 97 to 98 or any other aspect herein comprising determining a height (z-dimension) profile of an air gap of the block cave mine, the height profile comprising a height (z-dimension) of the air gap at a plurality of transverse (x, y) locations.
103. The method of aspect 102 or any other aspect herein wherein determining the height profile of the air gap comprises, for each transverse (x, y) location, determining a distance between the cave back surface model and the muck pile surface model.
104. The method of any one of aspects 102 to 103 or any other aspect herein comprising determining a safety risk associated with the block cave mine, the safety risk based at least in part on the determined height profile of the air gap.
105. The method of aspect 104 or any other aspect herein wherein determining the safety risk is based at least in part on one or more of: a depth of a muck pile of the block cave mine; a density of the muck pile, a number of open extraction channels of the block cave mine; locations of open extraction channels of the block cave mine; and water ingress into the block cave mine.
106. The method of any one of aspects 93 to 105 or any other aspect herein comprising determining one or more extraction channels from which to extract rock from the block cave mine based at least in part on the optimal values for the plurality of model parameters.
107. The method of any one of aspects 93 to 106 or any other aspect herein comprising determining one or more locations to induce fracturing of or an ore body of the block cave mine based at least in part on the optimal values for the plurality of model parameters.
108. The method of any one of aspects 93 to 107 or any other aspect herein wherein the measured directional muon intensities have associated uncertainties and wherein optimizing the objective function comprises accounting for the uncertainties in the measured directional muon intensities to thereby provide the optimal values for the plurality of model parameters with corresponding model parameter uncertainties.
109. The method of any one of aspects 93 to 118 or any other aspect herein wherein the optimal values for the plurality of model parameters comprise probability densities or probability distributions of the values for the plurality of model parameters.
110. The method of any one of aspects 93 to 109 or any other aspect herein wherein optimizing the objective function comprises performing a Bayesian optimization process.
111. The method of any one of aspects 93 to 110 or any other aspect herein wherein optimizing the objective function comprises performing a Monte Carlo optimization process.
112. The method of aspect 111 or any other aspect herein wherein the Monte Carlo optimization process comprises one of more of: a Markov Chain Monte Carlo process and a sequential Monte Carlo process.
113. The method of any one of aspects 93 to 112 or any other aspect herein wherein optimizing the objective function is based at least in part on prior mine information.
114. The method of aspect 113 or any other aspect herein wherein the modelled directional muon intensities are based at least in part on the prior mine information.
115. The method of any one of aspects 113 to 114 or any other aspect herein wherein optimizing the objective function based at least in part on the prior mine information comprises incorporating the prior mine information into the optimization as one or more constraints.
116. The method of aspect 115 or any other aspect herein wherein incorporating the prior mine information into the optimization as one or more constraints comprises incorporating the one or more constraints into the objective function.
117. The method of any one of aspects 115 to 116 or any other aspect herein wherein incorporating the prior mine information into the optimization as one or more constraints comprises limiting a solution space of the optimization based on the one or more constraints.
118. The method of any one of aspects 113 to 117 or any other aspect herein wherein the prior mine information comprises geometrical information which defines one or more regions of the block cave mine, the one or more regions selected from the group comprising: an ore body, an air gap and a muck pile.
119. The method of any one of aspects 113 to 118 or any other aspect herein wherein the prior mine information comprises density profile information which defines densities in one or more regions of the block cave mine, the one or more regions selected from the group comprising: an ore body, an air gap, a muck pile and earth adjacent to the ore body.
120. The method of any one of aspects 113 to 118 or any other aspect herein wherein the prior mine information comprises density profile information which defines a density for each of a plurality of voxels.
121. The method of any one of aspects 113 to 120 or any other aspect herein wherein the prior mine information comprises one or more of: information determined in a previous iteration of the optimization; and information determined prior to performing any iterations of the optimization.
122. The method of any one of aspects 93 to 121 or any other aspect herein wherein optimizing the objective function is based at least in part on additional measured information.
123. The method of aspect 122 or any other aspect herein wherein the additional measured information comprises one of more of: gravimetric information detected by one or more gravimetric sensors; seismic information detected by one or more seismic sensors; Radio Frequency Identification (RFID) information from one or more RFI_{D} devices; smart beacon information from one or more smart beacon devices; and image data from one or more downhole cameras.
124. The method of any one of aspects 122 to 123 wherein optimizing the objective function based at least in part on the additional measured information comprises incorporating the additional measured information into the optimization as one or more constraints.
125. The method of aspect 124 or any other aspect herein wherein incorporating the additional measured information into the optimization as one or more constraints comprises incorporating the one or more constraints into the objective function.
126. The method of any one of aspects 124 and 125 or any other aspect herein wherein incorporating the additional measured information into the optimization as one or more constraints comprises limiting a solution space of the optimization based on the one or more constraints.
127. The method of any one of aspects 122 to 126 or any other aspect herein wherein optimizing the objective function based at least in part on the additional measured information comprises performing a joint optimization.
128. The method of any one of aspects 93 to 127 or any other aspect herein wherein optimizing the objective function comprises performing tomographic reconstruction based at least in part on the measured directional muon intensities.
129. The method of aspect 128 or any other aspect herein wherein the objective function is based at least in part on the tomographic reconstruction.
130. The method of any one of aspects 128 to 129 or any other aspect herein wherein the modelled directional muon intensities are based at least in part on the tomographic reconstruction.
131. The method of any one of aspects 93 to 130 or any other aspect herein comprising repeating the steps of aspect 1 over a plurality of time periods to provide a temporal model of the block cave mine, the temporal model characterized by the optimal values for the plurality of model parameters determined for each time period.
132. The method of aspect 131 or any other aspect herein wherein the plurality of time periods comprise: a plurality of overlapping time periods; and a plurality of sequential time periods.
133. The method of any one of aspects 93 to 132 or any other aspect herein wherein at least one sub-plurality of muon detector locations are provided by a single muon detector.
134. A system for modelling a block cave mine, the system comprising:
   a plurality of spaced apart muon detectors distributed in, or in a vicinity of the block cave mine, each muon detector detecting muons that interact with the muon detector over a time period at one or more corresponding muon detection locations; and
   a controller in communication with the muon detectors, the controller configured to:
   determine modelled directional muon intensities based on a density model of the block cave mine;
   detect muons traversing through the block cave mine to generate muon trajectory data;
   determine measured directional muon intensities based on the muon trajectory data; and
   optimize an objective function that attributes cost to a difference between the measured directional muon intensities and the modelled directional muon intensities to thereby obtain a plurality of optimal values for a plurality of model parameters which parameterize a model of the block cave mine.
135. The system of aspect 134 or any other aspect herein wherein the controller is configured to perform any of the steps, combinations of steps and/or sub-combinations of steps of any of the methods
136. Methods comprising any features combinations of features and/or sub-combinations of features described herein.
137. Apparatus comprising any features combinations of features and/or sub-combinations of features described herein.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A method for modelling a block cave mine, the method comprising:
at each of a plurality of spaced apart muon detection locations in, or in a vicinity, of the block cave mine: detecting muons that interact with a muon detector over a time period; and determining, from the interactions, measured directional muon intensities for a plurality of directions intersecting at the muon detection location; and
optimizing an objective function to thereby obtain optimal values for a plurality of model parameters which parameterize a model of the block cave mine, wherein the objective function attributes cost to a difference between the measured directional muon intensities at the plurality of muon detection locations and modelled directional muon intensities at the plurality of muon detection locations.

2. The method of claim 1 wherein the modelled directional muon intensities are based at least in part on the model parameters.

3. The method of claim 1 wherein the model parameters comprise: cave back surface model parameters which parameterize a model of a cave back surface of the block cave mine; and upper muck pile surface model parameters which parameterize a model of an upper muck pile surface of the block cave mine.

4. The method of claim 3 wherein:
the cave back surface model parameters comprise three-dimensional locations of a plurality of vertices of a polygonal surface mesh that models the cave back surface; and
the upper muck pile surface model parameters comprise three-dimensional locations of a plurality of vertices of a polygonal surface mesh that models the upper muck pile surface.

5. The method of claim 1 wherein the model parameters comprise density profile parameters, which assign a density to each of a plurality of three-dimensional voxels in the block cave mine.

6. The method of claim 5 wherein the density profile parameters also assign a density to each of a plurality of three-dimensional voxels in the earth adjacent to the block cave.

7. The method of claim 5 wherein the voxels are polyhedral.

8. The method of claim 3 comprising determining a height (z-dimension) profile of an air gap of the block cave mine, the height profile comprising a height (z-dimension) of the air gap at a plurality of transverse (x, y) locations.

9. The method of claim 8 wherein determining the height profile of the air gap comprises, for each transverse (x, y) location, determining a distance between the cave back surface model and the muck pile surface model.

10. The method of claim 8 comprising determining a safety risk associated with the block cave mine, the safety risk based at least in part on the determined height profile of the air gap.

11. The method of claim 10 wherein determining the safety risk is based at least in part on one or more of: a depth of a muck pile of the block cave mine; a density of the muck pile, a number of open extraction channels of the block cave mine; locations of open extraction channels of the block cave mine; and
water ingress into the block cave mine.

12. The method of claim 1 comprising determining one or more extraction channels from which to extract rock from the block cave mine based at least in part the optimal values for the model parameters.

13. The method of claim 1 comprising determining one or more locations to induce fracturing of or an ore body of the block cave mine based at least in part on the optimal values for the model parameters.

14. The method of claim 1 wherein the measured directional muon intensities have associated uncertainties and wherein optimizing the objective function comprises accounting for the uncertainties in the measured directional muon intensities to thereby provide the optimal values of the model parameters with corresponding model parameter uncertainties.

15. The method of claim 1 wherein the optimal values of the model parameters comprise probability densities or probability distributions of the values of the model parameters.

16. The method of claim 1 wherein optimizing the objective function comprises performing a Bayesian optimization process.

17. The method of claim1 wherein optimizing the objective functions comprises performing a Monte Carlo optimization process.

18. The method of claim 17 wherein the Monte Carlo optimization process comprises one of more of: a Markov Chain Monte Carlo process and a sequential Monte Carlo process.

19. The method of claim 1 wherein optimizing the objective function is based at least in part on prior mine information.

20. The method of claim 19 wherein the modelled directional muon intensities are based at least in part on the prior mine information.
